(19) United States
(12) Patent Application Publication
(10) Pub. No.: US 2024/0261686 A1
(43) Pub. Date: Aug. 8, 2024

(54) VIRTUAL CHARACTER CONTROL METHOD, AND TERMINAL, ELECTRONIC DEVICE AND STORAGE MEDIUM

(71) Applicant: Beijing Zitiao Network Technology Co., Ltd., Haidian District, Beijing (CN)

(72) Inventor: Yuran Hu, Beijing (CN)

(21) Appl. No.: 18/566,556

(22) PCT Filed: Oct. 21, 2022
(86) PCT No.: PCT/CN2022/126788

§ 371 Date: Dec. 1, 2023

(30) Foreign Application Priority Data
Dec. 8, 2021 (CN) 202111495838.9

(51) Int. Cl. A63F 13/56; A63F 13/52; G06F 3/04817

(52) U.S. Cl. CPC A63F 13/56; A63F 13/52; G06F 3/04817

(57) ABSTRACT

The disclosure provides a virtual character control method, a terminal, an electronic device, and a storage medium, which may improve the virtual character control method in conventional games. The disclosure may adjust the moving direction while a generated sub-character is moving along its initial moving direction, so that the actual arrival position is adjusted. The disclosure synchronously implements various game features of a client game, enhancing virtual character control efficiency of users in fighting. In addition, the disclosure enables quick, flexible display and control of sub-characters in the game. With more innovativeness, the disclosure also offers convenience to users, and eases control and saves users' time, thusly improving the users' game experience.

### CROSS-REFERENCE TO RELATED APPLICATION(S)

This application claims priority to Chinese Application No. 202111495838.9 titled “Virtual Character Control Method, And Terminal, Electronic Device and Storage Medium” filed on Dec. 8, 2021, the disclosure of which is incorporated herein by reference in its entity.

### FIELD

The disclosure relates to the field of games, and more particularly relates to a virtual character control method, a terminal, an electronic device, and a storage medium.

### BACKGROUND

Character skills are crucial to a game. In recent years, online games usually provide a variety of game characters for a player to choose from, each game character having its own corresponding game skills. Among the variety of skills, the skill of sub-character generation has become increasingly favorable among players. In an actual game battle, a sub-character of a player can deceive an opponent in the fighting, interfere with the opponent's judgement and action, and aid the player to fight.

With popularity of smart terminals such as mobile phones, tablet computers, and wearable devices, gaming on a smart terminal has become a first choice for more and more players. However, smart terminals are limited in terms of input manners and control manners, so that gameplays adapted to the smart terminals lack diversity, rendering poor playability of games.

### SUMMARY

Embodiments of the disclosure at least provide a virtual character control method, a terminal, an electronic device, a storage medium, a computer program product, and a computer program.

Embodiments of the disclosure provide a virtual character control method, the method comprising:
displaying a game scene in an interface;
controlling, responsive to a first operation on a virtual character in the game scene, the virtual character to generate a sub-character;
determining, based on the first operation, an initial moving direction of the sub-character;
adjusting, while the sub-character is moving along the initial moving direction, a real-time moving direction of the sub-character during moving responsive to a second operation on the sub-character, allowing for the sub-character to move to a sub-character target position along the real-time moving direction; and
controlling, responsive to a third operation on the virtual character, the virtual character to move to the sub-character target position.

In an optional implementation, after controlling, responsive to the first operation on the virtual character in the game scene, the virtual character to generate the sub-character, the method comprises:
controlling, responsive to a fourth operation applied on a preset move icon with respect to the virtual character, the virtual character to act while the sub-character is moving, wherein the preset move icon is an identifier of a move control for controlling the virtual character to act.

In an optional implementation, controlling, responsive to the third operation on the virtual character, the virtual character to move to the sub-character target position comprises:
determining, upon reception of the third operation on the virtual character, a character position where the virtual character is located and a sub-character target position where the sub-character stops moving; and
controlling, responsive to the third operation, to not display the virtual character at the character position and to not display the sub-character at the sub-character target position, and controlling to display the virtual character at the sub-character target position to replace the sub-character.

In an optional implementation, in a case that the second operation is a first sliding operation, adjusting, while the sub-character is moving along the initial moving direction, the real-time moving direction of the moving sub-character responsive to the second operation on the sub-character, allowing for the sub-character to move to the sub-character target position along the real-time moving direction comprises:
obtaining, upon detecting the first sliding operation applied on a preset skill icon, a preset icon position of the preset skill icon in a graphical user interface, wherein the preset skill icon is an identifier of a skill control for generating the sub-character;
obtaining, while the preset skill icon is moving with the first sliding operation, a real-time icon position of the preset skill icon; and
adjusting, while the sub-character is moving along the initial moving direction, a real-time moving direction of the moving sub-character based on the present icon position and the real-time icon position, allowing for the sub-character to move to the sub-character target position along the real-time moving direction.

In an optional implementation, adjusting, while the sub-character is moving along the initial moving direction, the real-time moving direction of the moving sub-character based on the present icon position and the real-time icon position, allowing for the sub-character to move to the sub-character target position along the real-time moving direction comprises:
determining a first direction of the sub-character moving along the initial moving direction;
determining a second direction from the preset icon position towards the real-time icon position; and
adjusting, while the sub-character is moving along the initial moving direction, a real-time moving direction of the sub-character during moving based on a first included angle between the first direction and the second direction, allowing for the sub-character to move to the sub-character target position along the real-time moving direction.

In an optional implementation, reception of the first operation on the virtual character is determined by:
determining, upon detecting an operation applied on the preset skill icon, reception of the first operation on the virtual character; or
determining, upon detecting that a sliding start position of the first sliding operation is located on the preset skill icon, reception of the first operation on the virtual character.

In an optional implementation, in a case that the virtual character generates at least two sub-characters, determining, based on the first operation, the initial moving direction of the sub-character comprises:
selecting one sub-character from among the at least two sub-characters as a reference sub-character;
determining a relative positional relationship between the reference sub-character and each other sub-character than the reference sub-character in the at least two sub-characters;
determining, based on the first operation, a first initial moving direction of the reference sub-character; and
determining, for each other sub-character, a second initial moving direction of the other sub-character based on the relative positional relationship between the reference sub-character and the other sub-character.

In an optional implementation, adjusting, while the sub-character is moving along the initial moving direction, the real-time moving direction of the moving sub-character responsive to the second operation on the sub-character, allowing for the sub-character to move to the sub-character target position along the real-time moving direction comprises:
adjusting, while the reference sub-character is moving along the first initial moving direction, a reference real-time moving direction of the reference sub-character based on the second operation on the sub-character; and
adjusting, for each other sub-character, the real-time moving direction of the other sub-character based on the reference real-time moving direction and the relative positional relationship between the reference sub-character and the other sub-character, allowing for the sub-character to move to the sub-character target position along the real-time moving direction.

In an optional implementation, in a case that the third operation is a second sliding operation, controlling, responsive to the third operation on the virtual character, the virtual character to move to the sub-character target position comprises:
obtaining, upon detecting the second sliding operation applied on a preset skill icon, a preset icon position of the preset skill icon in the graphical user interface and a real-time icon position of the preset skill icon during moving with the second sliding operation, wherein the preset skill icon is an identifier of a skill control for generating the at least two sub-characters;
determining a third direction from the preset icon position towards the real-time icon position;
obtaining a fourth direction along which each sub-character moves towards its corresponding position;
determining a target sub-character from among the at least two sub-characters, wherein a second included angle between the third direction and the fourth direction corresponding to the target sub-character is smaller than respective second included angles between the third direction and other fourth directions corresponding to the other sub-characters in the at least two sub-characters; and
controlling to display the virtual character at a sub-character target position where the target sub-character stops moving, so as to replace the target sub-character.

Embodiments of the disclosure further provide a terminal, the terminal comprising:
a scene displaying module configured to display a game scene in an interface;
a sub-character generating module configured to control, responsive to a first operation on a virtual character in the game scene, the virtual character to generate a sub-character;
a position determining module configured to determine, based on the first operation, an initial moving direction of the sub-character;
a direction adjusting module configured to adjust, while the sub-character is moving along the initial moving direction, a real-time moving direction of the sub-character during moving responsive to a second operation on the sub-character, allowing for the sub-character to move to a sub-character target position along the real-time moving direction; and
a sub-character replacing module configured to control, responsive to a third operation on the virtual character, the virtual character to move to the sub-character target position.

In an optional implementation, the terminal further comprises a virtual character controlling module, the virtual character controlling module is configured to:
control, responsive to a fourth operation applied on a preset move icon with respect to the virtual character, the virtual character to act while the sub-character is moving, wherein the preset move icon is an identifier of a move control for controlling the virtual character to act.

In an optional implementation, the sub-character replacing module is specifically configured to:
determine, upon reception of the third operation on the virtual character, a character position where the virtual character is located and a sub-character target position where the sub-character stops moving; and
control, responsive to the third operation, to not display the virtual character at the character position, and to not display the sub-character at the sub-character target position, and control the virtual character to display at the sub-character target position to replace the sub-character.

In an optional implementation, in a case that the second operation is a first sliding operation, the direction adjusting module is specifically configured to:
obtain, upon detecting the first sliding operation applied on a preset skill icon, a preset icon position of the preset skill icon in a graphical user interface, wherein the preset skill icon is an identifier of a skill control for generating the sub-character;
obtain, while the preset skill icon is moving with the first sliding operation, a real-time icon position of the preset skill icon; and
adjust, while the sub-character is moving along the initial moving direction, a real-time moving direction of the sub-character during moving based on the present icon position and the real-time icon position, allowing for the sub-character to move to the sub-character target position along the real-time moving direction.

In an optional implementation, the direction adjusting module, when being configured to adjust, while the sub-character is moving along the initial moving direction, a real-time moving direction of the sub-character during moving based on the present icon position and the real-time icon position, allowing for the sub-character to move to the sub-character target position along the real-time moving direction, is specifically configured to:
determine a first direction of the sub-character moving along the initial moving direction;
determine a second direction from the preset icon position towards the real-time icon position; and
adjust, while the sub-character is moving along the initial moving direction, the real-time moving direction of the moving sub-character based on a first included angle between the first direction and the second direction, allowing for the sub-character to move to the sub-character target position along the real-time moving direction.

In an optional implementation, the sub-character generating module is configured to determine reception of the first operation on the virtual character by:
determining, upon detecting an operation applied on the preset skill icon, reception of the first operation on the virtual character; or
determining, upon detecting that a sliding start position of the first sliding operation is located on the preset skill icon, reception of the first operation on the virtual character.

In an optional implementation, in a case that the virtual character generates at least two sub-characters, the position determining module is specifically configured to:
select one sub-character from among the at least two sub-characters as a reference sub-character;
determine a relative positional relationship between the reference sub-character and each other sub-character than the reference sub-character in the at least two sub-characters;
determine, based on the first operation, a first initial moving direction of the reference sub-character; and
determine, for each other sub-character, a second initial moving direction of the other sub-character based on the relative positional relationship between the reference sub-character and the other sub-character.

In an optional implementation, the direction adjusting module is specifically configured to:
adjust, while the reference sub-character is moving along the first initial moving direction, a reference real-time moving direction of the reference sub-character based on a second operation on the sub-character; and
adjust, for each other sub-character, a real-time moving direction of the other sub-character based on the reference real-time moving direction and the relative positional relationship between the reference sub-character and the other sub-character, allowing for the sub-character to move to the sub-character target position along the real-time moving direction.

In an optional implementation, in a case that the third operation is a second sliding operation, the sub-character replacing module is specifically configured to:
obtain, upon detecting the second sliding operation applied on a preset skill icon, a preset icon position of the preset skill icon in the graphical user interface and a real-time icon position of the preset skill icon during moving with the second sliding operation, wherein the preset skill icon is an identifier of a skill control for generating the at least two sub-characters;
determine a third direction from the preset icon position towards the real-time icon position;
obtain a fourth direction along which each sub-character moves towards its corresponding position;
determine a target sub-character from among the at least two sub-characters, wherein a second included angle between the third direction and the fourth direction corresponding to the target sub-character is smaller than respective second included angles between the third direction and other fourth directions corresponding to other sub-characters in the at least two sub-characters; and
control to display the virtual character at a target position where the target sub-character stops moving, so as to replace the target sub-character.

Embodiments of the disclosure further provide an electronic device, comprising: a processor, a memory, and a bus, wherein machine-readable instructions executable by the processor are stored in the memory, and when the electronic device is operating, the processor and the memory communicate via the bus, the machine-readable instructions, when being executed by the processor, implementing steps of the virtual character control method noted supra.

Embodiments of the disclosure further provide a computer-readable storage medium, having a computer program stored thereon, which, when being executed by a processor, cause the processor to implement steps of the virtual character control method as noted supra.

Embodiments of the disclosure further provide a computer program product, comprising a computer program, wherein the computer program, when being executed by a processor, implements steps of the virtual character control method as noted supra.

Embodiments of the disclosure further provide a computer program, comprising program instructions, wherein the program instructions, when being executed by a processor, implements steps of the virtual character control method as noted supra.

Embodiments of the disclosure provide a virtual character control method, a terminal, an electronic device, a storage medium, a computer program product, and a computer, in which: a game scene is displayed in an interface; responsive to a first operation on a virtual character in the game scene, the virtual character is controlled to generate a sub-character; based on the first operation, an initial moving direction of the sub-character is determined; while the sub-character is moving along the initial moving direction, responsive to a second operation on the sub-character, a real-time moving direction of the moving sub-character is adjusted, allowing for the sub-character to move to a sub-character target position along the real-time moving direction; and responsive to a third operation on the virtual character, the virtual character is controlled to move to the sub-character target position.

In this manner, the disclosure may improve virtual character control methods in conventional game, which may adjust the moving direction while a generated sub-character is moving along its initial moving direction, so that the actual arrival position is adjusted. The disclosure synchronously implements various game features of a client game, enhancing virtual character control efficiency of users in fighting. In addition, the disclosure enables quick, flexible display and control of sub-characters in the game. With more innovativeness, the disclosure also offers convenience to users. The disclosure eases control and saves users' time, thusly improving the users' game experience.

To make the objectives, features, and advantages of the disclosure more apparent and comprehensible, example embodiments will be described in detail in conjunction with the accompanying drawings.

### BRIEF DESCRIPTION OF THE DRAWINGS

To illustrate the technical solutions in embodiments of the disclosure more clearly, the drawings referred to in the embodiments will be briefly introduced here, which are incorporated into the specification and constitute a portion of the specification. The drawings illustrate the embodiments in accordance with the disclosure and serve to explain the technical solutions of the disclosure in conjunction with the specification. It is understood that the drawings referred to infra only show some embodiments of the disclosure and thus shall not be deemed as limitations to the disclosure. To a person of normal skill in the art, other drawings may also be derived based on these drawings without exercise of inventive work.

FIG. 1 is a schematic diagram of an application scenario of a virtual character control method according to embodiments of the disclosure;

FIG. 2 is a flow diagram of a virtual character control method according to embodiments of the disclosure;

FIG. 3 is a first schematic diagram of sub-character control according to embodiments of the disclosure;

FIG. 4 is a second schematic diagram of sub-character control according to embodiments of the disclosure;

FIG. 5 is a third schematic diagram of sub-character control according to embodiments of the disclosure;

FIG. 6 is a flow diagram of another virtual character control method according to embodiments of the disclosure;

FIG. 7 is a schematic diagram of sub-character moving direction adjustment according to embodiments of the disclosure;

FIG. 8 is a schematic diagram of skill icon operation according to embodiments of the disclosure;

FIG. 9 is a schematic diagram of sub-character replacement according to embodiments of the disclosure;

FIG. 10 is a first schematic diagram of a terminal according to embodiments of the disclosure;

FIG. 11 is a second schematic diagram of a terminal according to embodiments of the disclosure; and

FIG. 12 is a schematic diagram of an electronic device according to embodiments of the disclosure.

### DETAILED DESCRIPTION OF EMBODIMENTS

To make the objectives, technical solutions, and advantages of the embodiments of the disclosure more apparent, the technical solutions in the embodiments of the disclosure will be described clearly and comprehensively with reference to the drawings in the embodiments of the disclosure. Apparently, the embodiments described herein are only part of the embodiments, not all of them. Generally, the components of the embodiments of the disclosure as depicted and illustrated in the drawings may be arranged and designed with various different configurations. Therefore, the detailed description of the embodiments of the disclosure provided in the drawings is not intended for limiting the scope of the disclosure sought for protection, but only representing the selected embodiments of the disclosure. All other embodiments derived, without exercise of inventive efforts, by those skilled in the art based on the embodiments described herein would fall within the scope sought for protection in the disclosure.

It is noted that like reference numbers and letters represent similar elements; therefore, once an element is defined in one figure, it would not be further defined and explained in subsequent figures.

The term “and/or” referred to herein only describes a correlated relationship, which may indicate presence of three relationships. For example, A and/or B may present: only A, both A and B, and only B. In addition, the term “at least one” referred to herein indicates any combination of at least two in any one or more of a set including multiple elements, e.g., comprising at least one of A, B, and C may indicate any one or more elements selected from a set including A, B, and C.

Studies reveal that with popularity of smart terminals such as mobile phones, tablet computers, and wearable devices, gaming on a smart terminal has become a first choice for more and more users. However, since smart terminals are limited in their input manners and control manners, gameplays adapted to the smart terminals lack diversity, rendering poor playability of games.

Based on the studies, the disclosure provides a virtual character control method, which may improve the virtual character control methods in conventional games. The method enables adjustment of the moving direction while a generated sub-character is moving along an initial moving direction, thereby adjusting its actual arrival position. The method may synchronously implement various game features of a client game, enhancing virtual character control efficiency of users in fighting. In addition, the method enables quick, flexible display and control of sub-characters in the game. With more innovativeness, the method also offers convenience to users. The method eases control and saves users' time, thusly improving the users' game experience.

To facilitate understanding of the embodiments, a virtual character control method according to embodiments of the disclosure will be first described in detail. An executing entity of the virtual character control method according to embodiments of the disclosure is generally an electronic device with certain computing capacity. The electronic device for example includes: a terminal device, or a server, or other processing devices. In some alternative implementations, the virtual character control method may also be implemented by a processor invoking computer-readable instructions stored in a memory.

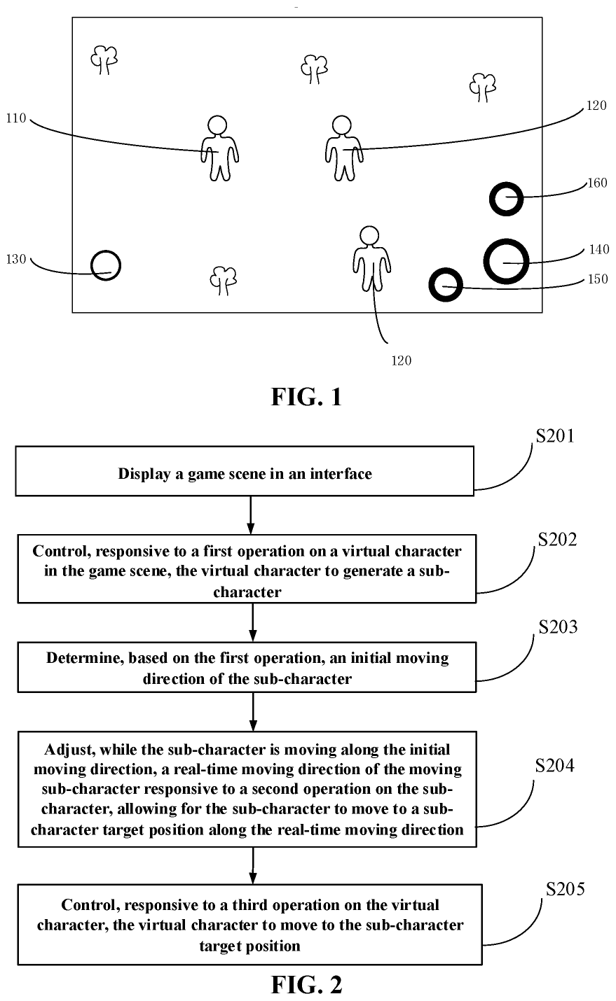

Please refer to FIG. 1, which illustrates a schematic diagram of an application scenario of a virtual character control method according to embodiments of the disclosure. The virtual character control method is applied in a terminal with a graphical user interface, e.g., a smart phone, a tablet computer, and a wearable device, etc. The graphical user interface may display at least part of a game scene. As illustrated in FIG. 1, the game scene includes a virtual character 110 controllable by a user, and a virtual character 120 as an enemy character or a friendly character. The graphical user interface further provides a control 130 for controlling movement of the virtual character 110, which is displayed in a manner of a control icon such as a virtual joystick or a virtual steering wheel, as well as controls for triggering a virtual character releasing skill, such as a preset skill icon 140, a preset skill icon 150, and a preset skill icon 160, etc.

Please refer to FIG. 2, which illustrates a flow diagram of the virtual character control method according to embodiments of the disclosure. As illustrated in FIG. 2, the virtual character control method according to embodiments of the disclosure comprises:

S201: a game scene is displayed in the interface.

S202: responsive to a first operation on a virtual character in the game scene, the virtual character is controlled to generate a sub-character.

In this step, it may detect whether an interactive operation applied by a user is received, and in a case of detecting the first operation applied by the user on the virtual character in the game scene, e.g., detecting an operation on one preset skill icon for sub-character generation, the virtual character may be controlled, responsive to the first operation, to generate the sub-character.

In this implementation, the preset skill icon refers to a skill identifier for controlling the virtual character to generate a sub-character. The preset skill icon may refer to the control 140 for triggering the virtual character releasing skill as illustrated in FIG. 1. The preset skill icon may take on a form of joystick or skill steering wheel, or the like.

In this implementation, the sub-character has a similar game effect to the virtual character by the skill releasing, which can survive certain time after the skill releasing.

In this implementation, the first operation may be an operation applied on the preset skill icon, such as clicking, pressing and holding, double clicking, forcibly pressing, and sliding.

S203: an initial moving direction of the sub-character is determined based on the first operation.

In this implementation, the initial moving direction may be a default moving direction along which the sub-character can reach a default target position, or may be a moving direction of the sub-character relative to the virtual character, which is adjusted from the default moving direction of the sub-character based operation information of the first operation. Examples of the operation information of the first operation include: acting duration and/or pressing force (such as pressing and holding, pressing, tapping, double tapping, etc.), dragging distance, dragging direction and dragging angle, and the like, applied on the preset skill icon.

Exemplarily, the initial moving direction may be determined by one or more of the following manners.

In a case that there is no enemy around the virtual character and the user does not apply a manual control, the initial moving direction is determined as a direction of a farthest position accessible along an orientation of the virtual character when the virtual character releases the skill without exceeding an accessible extent of the released skill.

In a case that there is an enemy around the virtual character and the user does not apply a manual control, the initial moving direction is determined as a direction closest to the enemy's position without exceeding the accessible extent of the released skill.

In a case that the user performs a manual control, the initial moving direction is determined responsive to a received operation applied by the user.

S204: while the sub-character is moving along the initial moving direction, a real-time moving direction of the sub-character is adjusted responsive to a second operation on the sub-character, allowing for the sub-character to move to a sub-character target position along the real-time moving direction.

In this step, while the sub-character is moving along the initial moving direction, it may detect whether an interactive operation applied by the user is received, and upon detecting the second operation applied by the user on the sub-character, a to-be-moved direction of the sub-character may be determined based on the second operation, so that the real-time moving direction of the sub-character during moving is adjusted based on the original moving direction of the sub-character, allowing for the sub-character, during moving to the sub-character target position, to move along the real-time moving direction.

Herein, while the sub-character is moving, the virtual character may act, or may not act.

Herein, the second operation may be an operation applied on the preset skill icon for generating the sub-character, such as clicking, pressing and holding, double-clicking, double tapping, and sliding.

Furthermore, the first operation and the second operation may be consecutive, i.e., they are different parts of a same operation. For example, in a case of a sliding operation applied on the preset skill icon, the first operation may be that at the beginning of the sliding operation, the user touches the preset skill icon and is ready to slide, which may be deemed as reception of the first operation. Then, the user slides to drag the preset skill icon to move, which may be deemed as reception of the second operation.

Correspondingly, in some optional implementations, reception of the first operation on the virtual character may be determined by the steps below.

Upon detecting that the sliding start position of the first sliding operation is on the preset skill icon, it is determined that the first operation on the virtual character is received.

In addition, upon detecting an operation applied on the preset skill icon, e.g., an operation independently applied on the preset skill icon, such as clicking, double clicking, pressing and holding, and double tapping, etc., it may be determined that the first operation on the virtual character is received.

Step S205: responsive to a third operation on the virtual character, the virtual character is controlled to move to the sub-character target position.

In this step, upon stopping adjustment of the real-time moving direction of the sub-character, the user may control the virtual character to replace the sub-character. Specifically, upon detecting the third operation applied by the user on the virtual character, i.e., to replace the sub-character with the virtual character, the target position where the sub-character stops moving may be determined, and the target position where the sub-character stops moving serves as a position to replace with the virtual character, whereby the virtual character is controlled to replace the sub-character at the target position.

Herein, the third operation may be an operation applied on the preset skill icon, such as clicking, pressing and holding, double clicking, double tapping, sliding, or the like.

Specifically, to control the virtual character moving to the sub-character target position, a character position where the virtual character is located and the sub-character target position where the sub-character stops moving upon reception of the third operation on the virtual character may be first determined, and then responsive to the third operation, it is controlled to not display the virtual character at the character position and to display the virtual character at the sub-character target position to replace the sub-character.

In this step, if the third operation on the virtual character is received during gaming, it may be deemed that the user intends to move the virtual character to the sub-character position. In this case, the character position where the virtual character is located and the sub-character target position where the sub-character stops moving may be first obtained, so that responsive to the third operation, it may be controlled to not display the virtual character at the character position and not display the sub-character at the sub-character target position, and further control to display the virtual character at the sub-character target position to replace the sub-character.

In this implementation, the character position may be a real-time position of the moving virtual character under control. The sub-character target position may be the preset position where the sub-character accesses after stopping movement, or a real-time position of the moving sub-character upon reception of the third operation.

Furthermore, it may be controlled to cause certain harm within a preset extent centered about the character position when the virtual character is not displayed at the character position.

Furthermore, it may also be controlled to cause certain harm within a preset extent centered about the sub-character target position when the virtual character is displayed at the sub-character target position.

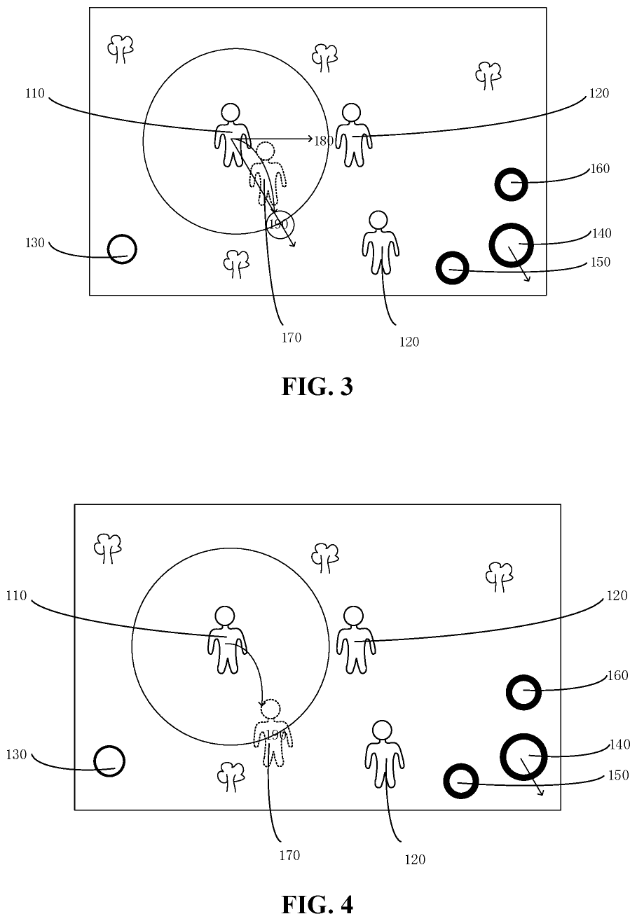

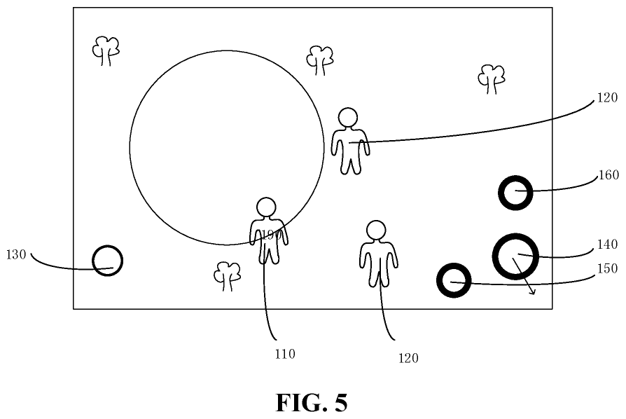

Exemplarily, referring to FIGS. 3 to 5, which illustrate schematic diagrams of sub-character control. As illustrated in FIGS. 3 to 5, upon detecting a first operation applied by a user on the preset skill icon 140 during gaming, e.g., clicking, pressing and holding, or dragging the preset skill icon 140, the virtual character 110 may be controlled to generate a sub-character 170. While generating the sub-character 170, an initial moving direction 180 of the sub-character 170 may be determined. While the sub-character 170 is moving along the initial moving direction 180, the user may apply a second operation on the sub-character 170, for example, the user may apply the second operation on the preset skill icon 140, to adjust the moving direction of the sub-character 170, so that the sub-character 170 can move to a target position 190 along the adjusted moving direction. After the sub-character 170 arrives at the target position 190, the user may control the virtual character 110 to transfer to the target position 190. Specifically, the third operation may be applied on the virtual character 110, e.g., applied on the preset skill icon 140, so as to control the virtual character 110 to transfer to the target position 190 and to cancel display of the sub-character 170 so as to achieve transfer and replacement of the position.

The virtual character control method according to embodiments of the disclosure improves the virtual character control methods in conventional games. The method enables adjustment of the moving direction while a generated sub-character is moving along an initial moving direction, thereby adjusting its actual arrival position. The method may synchronously implement various game features of a client game, enhancing virtual character control efficiency of users in fighting. In addition, the method enables quick, flexible display and control of sub-characters in the game. With more innovativeness, the method also offers convenience to the users. The method eases control and saves users' time, thusly improving the users' game experience.

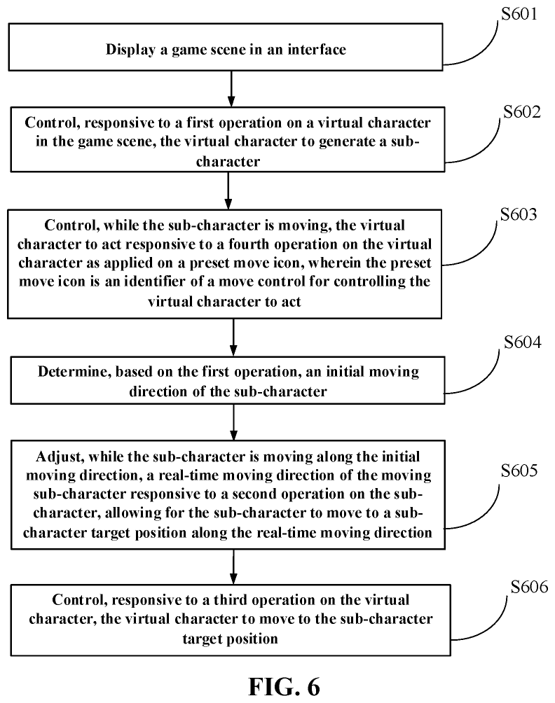

Please refer to FIG. 6, which illustrates a flow diagram of another virtual character control method according to embodiments of the disclosure. As illustrated in FIG. 6, the method comprises:

S601: a game scene is displayed in the interface.

S602: responsive to a first operation on a virtual character in the game scene, the virtual character is controlled to generate a sub-character.

S603: responsive to a fourth operation on the virtual character as applied on a preset move icon, the virtual character is controlled to act while the sub-character is moving, wherein the preset move icon is an identifier of a move control for controlling the virtual character to act.

In this step, the virtual character may be controlled to act at the same time of controlling the sub-character to act. Specifically, it may be detected whether the fourth operation on the virtual character as applied by the user on the preset move icon is received. Upon detecting the fourth operation, the virtual character may be controlled to act based on the fourth operation.

Herein, the preset move icon may refer to the control 130 configured to control the virtual character moving as illustrated in FIG. 1.

Herein, the fourth operation may be an operation applied on the preset move icon, such as clicking, pressing and holding, double-clicking, double tapping, and sliding, etc.

Herein, in order to control the virtual character moving, it is needed to determine the real-time moving direction of the virtual character. To achieve this, a preset icon position of the preset move icon in the graphical user interface may be first obtained, and a distance, an angle, and a direction of the real-time icon position of the preset move icon relative to the preset icon position upon action of the fourth operation may be obtained based on operation information of the fourth operation, such as acting duration, pressing force, dragging direction, dragging distance or the like applied on the preset move icon, so as to determine a real-time icon position of the preset move icon, whereby the virtual character's moving may be controlled.

S604: an initial moving direction of the sub-character is determined based on the first operation.

S605: while the sub-character is moving along the initial moving direction, responsive to the second operation on the sub-character, the real-time moving direction of the moving sub-character is adjusted, allowing for the sub-character to move to the sub-character target position along the real-time moving direction.

S606: responsive to the third operation on the virtual character, the virtual character is controlled to move to the sub-character target position.

Herein, the description of steps S601 to S602 and steps S604 to S606 may refer to the description of steps S201 to S205, with the same technical effect achieved and the same technical problem solved, which will thusly be omitted here.

Next, this embodiment will be further described in conjunction with some specific implementations.

In some optional implementations, in a case that the second operation is a first sliding operation, step S605 comprises the following operations.

Upon detecting the first sliding operation applied on the preset skill icon, the preset icon position of the preset skill icon in the graphical user interface is obtained, wherein the preset skill icon is an identifier of a skill control for generating the sub-character.

While the preset skill icon is moving with the first sliding operation, the real-time icon position of the preset skill icon is obtained.

While the sub-character is moving along the initial moving direction, the real-time moving direction of the moving sub-character is adjusted based on the preset icon position and the real-time icon position, allowing for the sub-character to move to the sub-character target position along the real-time moving direction.

In this step, while the sub-character is moving along the initial moving direction, if the first slide operating applied on the preset skill icon is received, it may be deemed that the user intends to adjust the real-time moving direction of the sub-character. In this case, in order to adjust the real-time moving direction of the sub-character, the preset icon position of the preset skill icon in the graphical user interface may be first obtained, and a distance, an angle, and a direction of the real-time icon position of the preset skill icon relative to the preset icon position upon action of the first sliding operation may be obtained based on operation information of the first sliding operation, such as acting duration, pressing force, dragging direction, dragging distance or the like applied on the preset move icon, so as to determine the real-time icon position of the preset skill icon, whereby the real-time moving direction of the sub-character during moving may be adjusted, allowing for the sub-character to move to the sub-character target position along the real-time moving direction.

In some optional implementations, step S605, while the sub-character is moving along the initial moving direction, responsive to the second operation on the sub-character, adjusting the real-time moving direction of the moving sub-character, allowing for the sub-character to move to the sub-character target position along the real-time moving direction, comprises the following operations.

A first direction of the sub-character moving along the initial moving direction is determined.

A second direction from the preset icon position towards the real-time icon position is determined.

While the sub-character is moving along the initial moving direction, the real-time moving direction of the sub-character during moving is adjusted based on a first included angle between the first direction and the second direction, allowing for the sub-character to move to the sub-character target position along the real-time moving direction.

In this step, in the course of adjusting the real-time moving direction of the sub-character, the initial moving direction when the sub-character starts moving and a to-be-adjusted target moving direction may be first determined. Specifically, based on a generation position where the sub-character is generated and the preset position accessible by the sub-character, the first direction along which the sub-character is to access the preset position from the generation position may be determined. The first direction may be deemed as the initial moving direction when the sub-character starts moving. Furthermore, while the preset skill icon is moving with the second operation, the real-time changing second direction of the preset skill icon may be determined based on the preset icon position and the real-time icon position. The second direction may be deemed as a target moving direction for the user to adjust the moving direction of the sub-character. Next, the real-time moving direction of the sub-character during moving may be adjusted based on the first included angle between the first direction and the second direction, thereby controlling the sub-character to gradually change to move along the second direction, so that the sub-character moves to the sub-character target position along the real-time moving direction.

In some optional embodiments, in a case that the virtual character generates at least two sub-characters, the step S604 comprises the following operations.

One sub-character is selected from among the at least two sub-characters as a reference sub-character.

A relative positional relationship between the reference sub-character and each other sub-character than the reference sub-character in the at least two sub-characters is determined.

A first initial moving direction of the reference sub-character is determined based on the first operation.

For each other sub-character, a second initial moving direction of the other sub-character is determined based on the relative positional relationship between the reference sub-character and the other sub-character.

In this step, in a case that the virtual character generates at least two sub-characters, one sub-character in the at least two sub-characters may be first selected as the reference sub-character, which reference sub-character may be a default reference sub-character in a skill mechanism. Alternatively, one sub-character may be selected as the reference sub-character from among the at least two sub-characters based on operation information of the second operation applied by the user on the preset skill icon. Next, the relative positional relationship between the reference sub-character and each other sub-character than the reference sub-character in the at least two sub-characters may be determined based on the position of the reference sub-character and the position of the other sub-character. To achieve this, the preset icon position of the preset skill icon in the graphical user interface may be first obtained, and a distance, an angle, and a direction of a real-time icon position of the preset skill icon relative to the preset icon position upon action of the first operation may be obtained based on operation information of the first operation, to determine the real-time icon position of the preset skill icon. Then, the first initial moving direction of the reference sub-character may be determined based on the preset icon position and the real-time icon position, so that for each other sub-character, the second initial moving direction of the other sub-character is determined based on the relative positional relationship between the other sub-character and the reference sub-character.

Herein, the operation information of the first operation may refer to factors such as acting duration, pressing force (such as pressing and holding, pressing, tapping, double tapping, etc.), dragging distance, dragging direction and dragging angle, as applied on the preset skill icon.

Furthermore, the operation of selecting the reference sub-character may be part of the first operation. Correspondingly, the operation of determining the first initial moving direction of the reference sub-character may be another part of the first operation. For example, the first operation may include two operations, one operation thereof being used to select the reference sub-character, and the other operation being used to determine the first initial moving direction of the reference sub-character.

In some optional embodiments, in a case that the virtual character generates at least two sub-characters, step S605 comprises the following operations.

While the reference sub-character is moving along the first initial moving direction, the reference real-time moving direction of the reference sub-character is adjusted based on a second operation on the sub-character.

For each other sub-character, the real-time moving direction of the other sub-character is adjusted based on the reference real-time moving direction and the relative positional relationship between the reference sub-character and the other sub-character, allowing for the sub-character to move to the sub-character target position along the real-time moving direction.

In this step, in a case that the virtual character generates at least two sub-characters, while the reference sub-character is moving along the first initial moving direction, the preset icon position of the preset skill icon in the graphical user interface may be first obtained, and a distance, an angle, and a direction of the real-time icon position of the preset skill icon relative to the preset icon position upon action of the second operation may be obtained based on operation information of the second operation, so as to determine the real-time icon position of the preset skill icon. Then the reference real-time moving direction of the reference sub-character may be adjusted based on the preset icon position and the real-time icon position, so that for each other sub-character, the real-time moving direction of the other sub-character is adjusted based on the reference real-time moving direction and the relative positional relationship between the other sub-character and the reference sub-character, allowing for all sub-characters move to their sub-character target positions along their real-time moving directions.

Herein, the operation information of the second operation may refer to factors such as acting duration, pressing force (such as pressing and holding, pressing, tapping, double tapping, etc.), dragging distance, dragging direction and dragging angle, as applied on the preset skill icon.

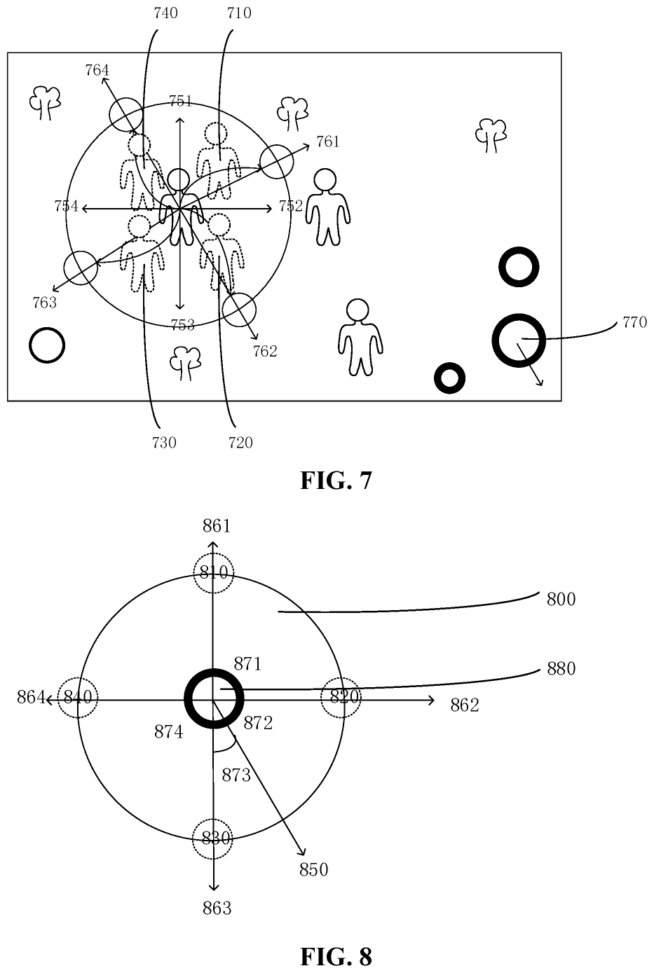

Exemplarily, please refer to FIG. 7, which is a schematic diagram of sub-character moving direction adjustment according to embodiments of the disclosure. FIG. 7 exemplarily illustrates four sub-characters, including sub-characters 710 to 740, the initial moving directions 751 to 754 of the four sub-characters, adjusted moving directions 761 to 764 of the four sub-characters, and a control for a preset skill icon 770 for triggering the virtual character releasing skill.

As illustrated in FIG. 7, during gaming, upon detecting a second operation applied by a user on the preset skill icon 770, for example, clicking, pressing and holding, or dragging the preset skill icon 770, the sub-character 720 may be selected as the reference sub-character from the four sub-characters 710 to 740. While the reference sub-character 720 is moving along the initial moving direction 752, the user may apply the second operation on the reference sub-character 720, e.g., the user may apply the second operation on the preset skill icon 770, to thereby adjust the reference sub-character 720 to move towards the direction 762. For each of the other rest sub-characters 710, 730, and 740 than the reference sub-character, while the sub-character 710 is moving along the initial moving direction 751, the sub-character 730 is moving along the initial moving direction 753, and the sub-character 740 is moving along the initial moving direction 754, respective real-time moving directions of the other sub-characters 710, 730, and 740 are adjusted based on respective relative positional relationships between the other sub-characters 710, 730, 740 and the reference sub-character 720. Correspondingly, the adjusted moving direction of the sub-character 710 is denoted as 761, the adjusted moving direction of the sub-character 730 is denoted as 763, and the adjusted moving direction of the sub-character 740 is denoted as 764.

In some optional implementations, in a case that the third operation refers to a second sliding operation, step S606 comprises the following operations.

Upon detecting the second sliding operation applied on the preset skill icon, the preset icon position of the preset skill icon in the graphical user interface and the real-time icon position of the preset skill icon during moving with the second sliding operation are obtained, wherein the preset skill icon is an identifier of the skill control for generating the at least two sub-characters.

A third direction from the preset icon position towards the real-time icon position is determined.

A fourth direction along which each sub-character moves towards its corresponding position is obtained.

A target sub-character is determined from among the at least two sub-characters, wherein a second included angle between the fourth direction corresponding to the target sub-character and the third direction is smaller than respective second included angles between the third direction and respective other fourth directions corresponding to the other sub-characters in the at least two sub-characters.

The virtual character is controlled to be displayed at the sub-character target position where the target sub-character stops moving, so as to replace the target sub-character.

In this step, upon receiving the second sliding operation applied on the preset skill icon during gaming, it may be deemed that the user intends to control the virtual character to replace the sub-character. At this point, the character position where the virtual character is located and the sub-character target position where the sub-character stops moving may be first obtained. To achieve this, the preset icon position of the preset skill icon in the graphical user interface may be first obtained. Under the action of the second sliding operation, the preset icon position of the preset skill icon in the graphical user interface and the real-time icon position of the preset skill icon during moving with the second sliding operation may be obtained based on operation information of the second sliding operation, examples of the operation information of the second sliding operation including factors such as acting duration and/or pressing force (e.g., pressing and holding, pressing, tapping, double tapping, etc.), dragging distance, dragging direction and dragging angle, as applied on the preset ski icon, whereby the third direction from the preset icon position towards the real-time icon position is determined. The fourth direction of each sub-character moving towards its corresponding position is further obtained, and further the second included angle between the fourth direction corresponding to the target sub-character and the third direction is obtained. The second included angles between the third direction and respective fourth directions corresponding to the other sub-characters in the at least two sub-characters are determined so as to determine the target sub-character from the at least two sub-characters, and then the virtual character may be controlled to display at the sub-character target position where the target sub-character stops moving, so as to replace the target sub-character.

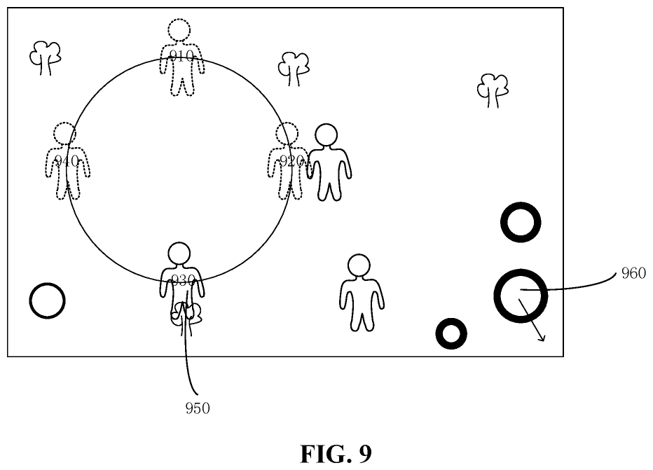

Exemplarily, please refer to FIGS. 8 and 9, which exemplarily illustrate four sub-characters. FIG. 8 is an operational schematic diagram according to embodiments of the disclosure, and FIG. 9 is a schematic diagram of sub-character replacement according to embodiments of the disclosure.

As illustrated in FIG. 8, positions of the sub-characters are mapped within an operational extent of the preset skill icon. The schematic figure illustrates: a control of a preset skill icon 880 for triggering the virtual character releasing skill, a maximum extent 800 accessible by dragging the preset skill icon 880, the real-time positions 810 to 840 of the four sub-characters, a third direction 850, fourth directions 861 to 864, and second included angles 871 to 874.

As illustrated in FIG. 8, upon detecting the second sliding operation applied by the user on the preset skill icon 880 during gaming, a dragging direction of the second sliding operation, i.e., the third direction 850, may be obtained, the real-time positions 810 to 840 of the four sub-characters may be obtained, and the real-time moving directions of the four sub-characters, i.e., the fourth directions 861 to 864, are determined, thereby respective second included angles 871 to 874 between the third direction 850 and the fourth directions 861 to 864 are obtained, from which the minimum included angle 873, i.e., the second included angle corresponding to the target sub-character, is determined, whereby the real-time position 830 of the target sub-character is determined.

As illustrated in FIG. 9, positions of the sub-characters are mapped within an operable extent of the preset skill icon. The schematic diagram illustrates: real-time positions 910 to 940 of the four sub-characters, a virtual character 950, and a control of a preset skill icon 960 for triggering the virtual character releasing skill.

As illustrated in FIG. 9, while the target sub-character is moving, the user may apply the third operation on the virtual character 950, e.g., the third operation applied on the preset skill icon 960, thereby controlling the virtual character 950 to move to the target position 930 where the target sub-character stops moving, thereby replacing the target sub-character. The other sub-characters than the replaced sub-character are still displayed at the real-time positions 910, 920, 940.

In some optional implementations, the real-time icon position of the preset skill icon during moving with the second sliding operation may be determined by one or more of:
a real-time position upon end of the second sliding operation, e.g., when the finger is lifted off the screen, it indicates end of the second sliding operation, and the position at this point serves as the real-time position; and
a position of the preset skill icon detected when skill releasing time of the preset skill icon arrives, wherein the position at this point serves as the real-time position.

In some optional implementations, a preset skill icon to trigger the virtual character to generate one sub-character and to generate multiple sub-characters is set by one or more of the following manners:
setting two preset skill icons to correspond to two scenarios of the virtual character's generating one sub-character and generating multiple sub-characters, respectively;
setting one preset skill icon to correspond to two scenarios of the virtual character's generating one sub-character and generating multiple sub-characters via different operations, respectively; wherein the different operations may be that the virtual character first generates one sub-character and then generates multiple sub-characters. For example, by clicking the preset skill icon, the virtual character may generate one sub-character, and by pressing and holding the preset skill icon, the virtual character may generate a plurality of sub-characters responsive to duration of touching the preset skill icon.

Correspondingly, in a case that two preset skill icons are set, the two preset skill icons are disposed at different positions.

The virtual character control method according to embodiments of the disclosure improves the virtual character control methods in conventional game. The method enables adjustment of the moving direction while a generated sub-character is moving along an initial moving direction, thereby adjusting its actual arrival position. The method may synchronously implement various game features of a client game, enhancing virtual character control efficiency of users in fighting. In addition, the method enables quick, flexible display and control of sub-characters in the game. With more innovativeness, the method also offers convenience to the users. The method eases control and saves users' time, thusly improving the users' game experience.

Those skilled in the art would appreciate that, in the specific implementations of the method described above, the described sequences of respective steps do not mean a strict execution sequence or constitute any limitation to the implementation process, and the specific execution sequence of respective steps should be determined based on their functions and possible inherent logics.

Based on the same inventive concept, embodiments of the disclosure further provide a terminal corresponding to the virtual character control method. As the principle employed by the terminal in embodiments of the disclosure to solve relevant problems is similar to the virtual character control method described supra, implementations of the terminal may refer to the implementations of the method, and overlapping contents will be thusly omitted.

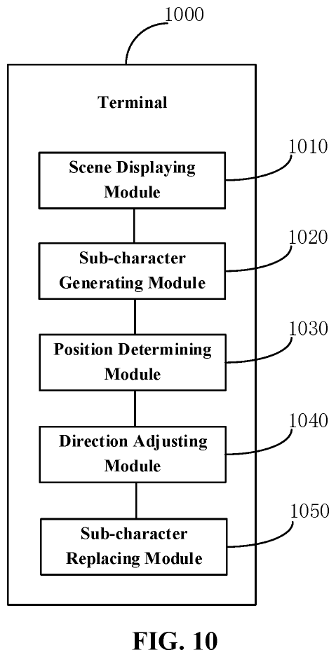

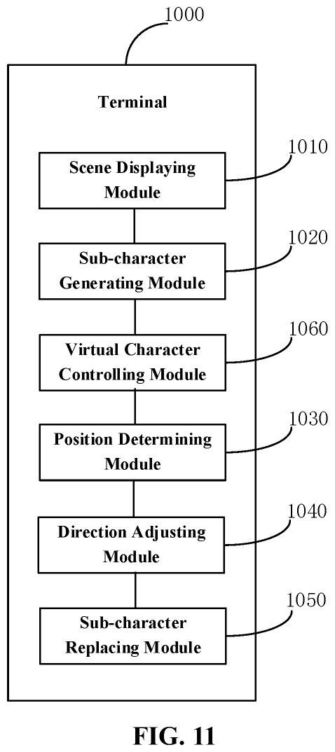

Please refer to FIGS. 10 and 11. FIG. 10 is a first schematic diagram of the terminal according to embodiments of the disclosure, and FIG. 11 is a second schematic diagram of the terminal according to embodiments of the disclosure. As illustrated in FIG. 10, a terminal 1000 according to embodiments of the disclosure comprises:
a scene displaying module 1010 configured to display a game scene in an interface;
a sub-character generating module 1020 configured to control, responsive to a first operation on a virtual character in the game scene, the virtual character to generate a sub-character;
a position determining module 1030 configured to determine, based on the first operation, an initial moving direction of the sub-character;
a direction adjusting module 1040 configured to adjust, while the sub-character is moving along the initial moving direction, responsive to a second operation on the sub-character, a real-time moving direction of the sub-character during moving, allowing for the sub-character to move to a sub-character target position along the real-time moving direction; and
a sub-character replacing module 1050 configured to control, responsive to a third operation on the virtual character, the virtual character to move to the sub-character target position.

In an optional implementation, the sub-character replacing module 1050 is specifically configured to:
determine, upon reception of the third operation on the virtual character, a character position where the virtual character is located and a sub-character target position where the sub-character stops moving; and
control, responsive to the third operation, to not display the virtual character at the character position, and to not display the sub-character at the sub-character target position, and control the virtual character to display at the sub-character target position to replace the sub-character.

In an optional implementation, in a case that the second operation is a first sliding operation, the direction adjusting module 1040 is specifically configured to:
obtain, upon detecting the first sliding operation applied on a preset skill icon, a preset icon position of the preset skill icon in a graphical user interface, wherein the preset skill icon is an identifier of a skill control for generating the sub-character;
obtain, while the preset skill icon is moving with the first sliding operation, a real-time icon position of the preset skill icon; and
adjust, while the sub-character is moving along the initial moving direction, a real-time moving direction of the sub-character during moving based on the present icon position and the real-time icon position, allowing for the sub-character to move to the sub-character target position along the real-time moving direction.

In an optional implementation, the direction adjusting module 1040, when being configured to adjust, while the sub-character is moving along the initial moving direction, a real-time moving direction of the sub-character during moving based on the present icon position and the real-time icon position, allowing for the sub-character to move to the sub-character target position along the real-time moving direction, is specifically configured to:
determine a first direction of the sub-character moving along the initial moving direction;
determine a second direction from the preset icon position towards the real-time icon position; and
adjust, while the sub-character is moving along the initial moving direction, the real-time moving direction of the moving sub-character based on a first included angle between the first direction and the second direction, allowing for the sub-character to move to the sub-character target position along the real-time moving direction.

In an optional implementation, the sub-character generating module 1020 is configured to determine reception of the first operation on the virtual character by:
determining, upon detecting an operation applied on the preset skill icon, reception of the first operation on the virtual character; or
determining, upon detecting that a sliding start position of the first sliding operation is located on the preset skill icon, reception of the first operation on the virtual character.

In an optional implementation, in a case that the virtual character generates at least two sub-characters, the position determining module 1030 is specifically configured to:
select one sub-character from among the at least two sub-characters as a reference sub-character;
determine a relative positional relationship between the reference sub-character and each other sub-character than the reference sub-character in the at least two sub-characters;
determine, based on the first operation, a first initial moving direction of the reference sub-character; and
determine, for each other sub-character, a second initial moving direction of the other sub-character based on the relative positional relationship between the reference sub-character and the other sub-character.

In an optional implementation, the direction adjusting module 1040 is specifically configured to:
adjust, while the reference sub-character is moving along the first initial moving direction, a reference real-time moving direction of the reference sub-character based on a second operation on the sub-character; and
adjust, for each other sub-character, a real-time moving direction of the other sub-character based on the reference real-time moving direction and the relative positional relationship between the reference sub-character and the other sub-character, allowing for the sub-character to move to the sub-character target position along the real-time moving direction.

In an optional implementation, in a case that the third operation is a second sliding operation, the sub-character replacing module 1050 is specifically configured to:
obtain, upon detecting the second sliding operation applied on a preset skill icon, a preset icon position of the preset skill icon in the graphical user interface and a real-time icon position of the preset skill icon during moving with the second sliding operation, wherein the preset skill icon is an identifier of a skill control for generating the at least two sub-characters;
determine a third direction from the preset icon position towards the real-time icon position;
obtain a fourth direction along which each sub-character moves towards its corresponding position;
determine a target sub-character from among the at least two sub-characters, wherein a second included angle between the third direction and the fourth direction corresponding to the target sub-character is smaller than respective second included angles between the third direction and other fourth directions corresponding to other sub-characters in the at least two sub-characters; and
control to display the virtual character at a target position where the target sub-character stops moving, so as to replace the target sub-character.

In an optional implementation, as illustrated in FIG. 11, the terminal 1000 further comprises a virtual character controlling module 1060, which is configured to:
control, responsive to a fourth operation applied on a preset move icon with respect to the virtual character, the virtual character to act while the sub-character is moving, wherein the preset move icon is an identifier of a move control for controlling the virtual character to act.

The terminal according to embodiments of the disclosure may improve virtual character control methods in conventional games. The terminal enables adjustment of the moving direction while a generated sub-character is moving along an initial moving direction, thereby adjusting its actual arrival position. The terminal may synchronously implement various game features of a client game, enhancing virtual character control efficiency of users in fighting. In addition, the terminal enables quick, flexible display and control of sub-characters in the game. With more innovativeness, the terminal also offers convenience to the users. The terminal eases control and saves users' time, thusly improving the users' game experience.

The processing flows of respective modules in the terminal and the interactive flows between the respective modules may refer to relevant depictions in the method embodiments, which will not be detailed here.

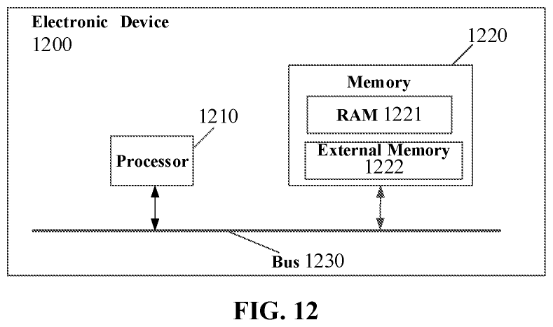

Corresponding to the virtual character control method, embodiments of the disclosure further provide an electronic device 1200. FIG. 12 illustrates a structural schematic diagram of an electronic device 1200 provided according to embodiments of the disclosure, comprising:
a processor 1210, a memory 1220, and a bus 1230. The memory 1220 is configured to store execution instructions, comprising a random access memory 1221 and an external memory 1222. The random access memory 1221 is also referred to as an internal memory, configured to temporary store operational data in the processor 1210 as well as data exchanged with the external memory 1222 such as a hard disk. The processor 1210 exchanges data with the external memory 1222 via the random access memory 1221. When the electronic device 1200 is operating, the processor 1210 and the memory 1220 communicate via the bus 1230, causing the processor 1210 to execute the steps of the virtual character control method described supra.

A specific execution process of the instructions may refer to the steps of the virtual character control method described in the embodiments of the disclosure, which will not be detailed here.

Embodiments of the disclosure further provide a computer-readable storage medium, the computer-readable storage medium has program codes stored thereon, which, when executed by a processor, cause the processor to perform steps of the virtual character control method described in the method embodiments. The storage medium may be a volatile or non-volatile computer-readable storage medium.

Embodiments of the disclosure further provide a computer program product, comprising a computer program, wherein the computer program, when being executed by a processor, performs steps of the virtual character control method described in the method embodiments. The details may refer to the method embodiments, which will not be repeated here.

Embodiments of the disclosure further provide a computer program, comprising program instructions, wherein the program instructions, when being executed by a processor, performs steps of the virtual character control method described in the method embodiments. The details may refer to the method embodiments, which will not be repeated here.

The computer program product may be implemented via hardware, software, or a combination thereof. In an alternative embodiment, the computer program product is embodied as a computer storage medium. In another alternative embodiment, the computer program product is embodied as a software product, e.g., a software development kit (SDK), etc.

Those skilled in the art would appreciate that, to facilitate a concise description, the specific operating processes of the terminal and electronic device described supra may refer to corresponding processes in the method embodiments, which will not be repeated here. It is understood that the method, terminal, and electronic device described in the example embodiments provided herein may also be implemented in other manners. The apparatus embodiments described supra are only schematic. For example, partitions of the units are only logical functional partitions, and alternative partition manners are allowed in actual implementations. For another example, multiple units or components may be combined or may integrated into another system, or some features may be omitted or may not be executed. It is further noted that, the illustrated or discussed coupling, direct coupling, or communication connection may be realized via some communication interfaces; the indirect coupling or communication connection between devices or units may be electric, mechanic, or other forms.

The units described as discrete components may be or may not be physically separated; components illustrated as units may be or may not be a physical unit; they may be located at one place, or may be distributed on a plurality of network elements. Part or all of the units may be selected to achieve the objectives of the embodiments of the disclosure dependent on actual needs.

Additionally, various functional units in various embodiments of the disclosure may be integrated into one processing unit, or the various units may be present standalone physically; or two or more units may be integrated into one unit.

If the functional units take on a form of software functional units and are sold or used as independent products, they may be stored in a processor-executable, non-volatile, computer-readable storage medium. Based on such understanding, a technical solution of the disclosure, or part of the disclosure contributing to the prior art, or part of the technical solution may be embodied as a software product. The computer software is stored in a storage medium, comprising a plurality of instructions causing a computer device (which may be a personal computer, a server, or a network device, etc.) to execute all or part of the steps of the method described in various embodiments of the disclosure. The storage medium noted supra includes various kinds of mediums which may store program codes, such as a U-disc, a mobile hard disc, a read-only memory (ROM), a random access memory (RAM), a magnetic disc, or an optical disc.

Finally, it is noted that, the embodiments described supra are only specific implementations of the disclosure for illustrating, not intended for limiting, the technical solutions of the disclosure, and the protection scope of the disclosure is not limited thereto. Although the disclosure has been described in detail with reference to the embodiments, those skilled in the art shall appreciate that, any person familiar with the relevant technical field may modify, or readily contemplate change to the technical solution described in the embodiments within the technical extent disclosed herein, or perform equivalent substitution to part of the technical features, while such modifications, changes, or replacements do not cause the essence of the corresponding technical solutions to depart from the spirit and scope of the technical solutions of the embodiments of the disclosure, all of which shall fall within the scope of protection of the disclosure. Therefore, the scope of protection of the disclosure shall be limited in the appended claims.

What is claimed is:

1. A virtual character control method, comprising:
displaying a game scene in an interface;
controlling, responsive to a first operation on a virtual character in the game scene, the virtual character to generate a sub-character;
determining, based on the first operation, an initial moving direction of the sub-character;
adjusting, while the sub-character is moving along the initial moving direction, a real-time moving direction of the sub-character during moving responsive to a second operation on the sub-character, allowing for the sub-character to move to a sub-character target position along the real-time moving direction; and
controlling, responsive to a third operation on the virtual character, the virtual character to move to the sub-character target position.

2. The method according to claim 1, wherein after controlling, responsive to the first operation on the virtual character in the game scene, the virtual character to generate the sub-character, the method comprises:
controlling, responsive to a fourth operation applied on a preset move icon with respect to the virtual character, the virtual character to act while the sub-character is moving, wherein the preset move icon is an identifier of a move control for controlling the virtual character to act.

3. The method according to claim 1, wherein controlling, responsive to the third operation on the virtual character, the virtual character to move to the sub-character target position comprises:
determining, upon reception of the third operation on the virtual character, a character position where the virtual character is located and a sub-character target position where the sub-character stops moving; and
controlling, responsive to the third operation, to not display the virtual character at the character position and to not display the sub-character at the sub-character target position, and controlling to display the virtual character at the sub-character target position to replace the sub-character.

4. The method according to claim 1, wherein in a case that the second operation is a first sliding operation, adjusting, while the sub-character is moving along the initial moving direction, the real-time moving direction of the moving sub-character responsive to the second operation on the sub-character, allowing for the sub-character to move to the sub-character target position along the real-time moving direction comprises:
obtaining, upon detecting the first sliding operation applied on a preset skill icon, a preset icon position of the preset skill icon in a graphical user interface, wherein the preset skill icon is an identifier of a skill control for generating the sub-character;
obtaining, while the preset skill icon is moving with the first sliding operation, a real-time icon position of the preset skill icon; and
adjusting, while the sub-character is moving along the initial moving direction, a real-time moving direction of the moving sub-character based on the present icon position and the real-time icon position, allowing for the sub-character to move to the sub-character target position along the real-time moving direction.

5. The method according to claim 4, wherein adjusting, while the sub-character is moving along the initial moving direction, the real-time moving direction of the moving sub-character based on the present icon position and the real-time icon position, allowing for the sub-character to move to the sub-character target position along the real-time moving direction comprises:
determining a first direction of the sub-character moving along the initial moving direction;
determining a second direction from the preset icon position towards the real-time icon position; and
adjusting, while the sub-character is moving along the initial moving direction, a real-time moving direction of the sub-character during moving based on a first included angle between the first direction and the second direction, allowing for the sub-character to move to the sub-character target position along the real-time moving direction.

6. The method according to claim 4, wherein reception of the first operation on the virtual character is determined by:
determining, upon detecting an operation applied on the preset skill icon, reception of the first operation on the virtual character; or
determining, upon detecting that a sliding start position of the first sliding operation is located on the preset skill icon, reception of the first operation on the virtual character.

7. The method according to claim 1, wherein in a case that the virtual character generates at least two sub-characters, determining, based on the first operation, the initial moving direction of the sub-character comprises:
selecting one sub-character from among the at least two sub-characters as a reference sub-character;
determining a relative positional relationship between the reference sub-character and each other sub-character than the reference sub-character in the at least two sub-characters;
determining, based on the first operation, a first initial moving direction of the reference sub-character; and
determining, for each other sub-character, a second initial moving direction of the other sub-character based on the relative positional relationship between the reference sub-character and the other sub-character.

8. The method according to claim 7, wherein adjusting, while the sub-character is moving along the initial moving direction, the real-time moving direction of the moving sub-character responsive to the second operation on the sub-character, allowing for the sub-character to move to the sub-character target position along the real-time moving direction comprises:
adjusting, while the reference sub-character is moving along the first initial moving direction, a reference real-time moving direction of the reference sub-character based on the second operation on the sub-character; and
adjusting, for each other sub-character, the real-time moving direction of the other sub-character based on the reference real-time moving direction and the relative positional relationship between the reference sub-character and the other sub-character, allowing for the other sub-character to move to its sub-character target position along its real-time moving direction.

9. The method according to claim 7, wherein in a case that the third operation is a second sliding operation, controlling, responsive to the third operation on the virtual character, the virtual character to move to the sub-character target position comprises:
obtaining, upon detecting the second sliding operation applied on a preset skill icon, a preset icon position of the preset skill icon in the graphical user interface and a real-time icon position of the preset skill icon during moving with the second sliding operation, wherein the preset skill icon is an identifier of a skill control for generating the at least two sub-characters;
determining a third direction from the preset icon position towards the real-time icon position;
obtaining a fourth direction along which each sub-character moves towards its corresponding position;
determining a target sub-character from among the at least two sub-characters, wherein a second included angle between the third direction and the fourth direction corresponding to the target sub-character is smaller than respective second included angles between the third direction and other fourth directions corresponding to the other sub-characters in the at least two sub-characters; and
controlling to display the virtual character at a sub-character target position where the target sub-character stops moving, so as to replace the target sub-character.

10. (canceled)

11. An electronic device, comprising: a processor, a memory, and a bus,
wherein machine-readable instructions executable by the processor are stored in the memory, and when the electronic device is operating, the processor and the memory communicate via the bus, the machine-readable instructions, when being executed by the processor, cause the electronic device to:
display a game scene in an interface;
control, responsive to a first operation on a virtual character in the game scene, the virtual character to generate a sub-character;
determine, based on the first operation, an initial moving direction of the sub-character;
adjust, while the sub-character is moving along the initial moving direction, a real-time moving direction of the sub-character during moving responsive to a second operation on the sub-character, allowing for the sub-character to move to a sub-character target position along the real-time moving direction; and
control, responsive to a third operation on the virtual character, the virtual character to move to the sub-character target position.

12. A non-transitory computer-readable storage medium, having a computer program stored thereon, which, when being executed by a processor, cause the processor to
display a game scene in an interface;
control, responsive to a first operation on a virtual character in the game scene, the virtual character to generate a sub-character;
determine, based on the first operation, an initial moving direction of the sub-character;
adjust, while the sub-character is moving along the initial moving direction, a real-time moving direction of the sub-character during moving responsive to a second operation on the sub-character, allowing for the sub-character to move to a sub-character target position along the real-time moving direction; and
control, responsive to a third operation on the virtual character, the virtual character to move to the sub-character target position.

13. (canceled)

14. (canceled)

15. The electronic device according to claim 11, wherein the machine-readable instructions, when being executed by the processor, further cause the electronic device to:
control, responsive to a fourth operation applied on a preset move icon with respect to the virtual character, the virtual character to act while the sub-character is moving, wherein the preset move icon is an identifier of a move control for controlling the virtual character to act.

16. The electronic device according to claim 11, wherein the machine-readable instructions, when being executed by the processor, further cause the electronic device to:
determine, upon reception of the third operation on the virtual character, a character position where the virtual character is located and a sub-character target position where the sub-character stops moving; and
control, responsive to the third operation, to not display the virtual character at the character position and to not display the sub-character at the sub-character target position, and controlling to display the virtual character at the sub-character target position to replace the sub-character.

17. The electronic device according to claim 11, wherein in a case that the second operation is a first sliding operation, the machine-readable instructions, when being executed by the processor, further cause the electronic device to:
obtain, upon detecting the first sliding operation applied on a preset skill icon, a preset icon position of the preset skill icon in a graphical user interface, wherein the preset skill icon is an identifier of a skill control for generating the sub-character;
obtain, while the preset skill icon is moving with the first sliding operation, a real-time icon position of the preset skill icon; and
adjust, while the sub-character is moving along the initial moving direction, a real-time moving direction of the moving sub-character based on the present icon position and the real-time icon position, allowing for the sub-character to move to the sub-character target position along the real-time moving direction.

18. The electronic device according to claim 17, wherein the machine-readable instructions, when being executed by the processor, further cause the electronic device to:
determine a first direction of the sub-character moving along the initial moving direction;
determine a second direction from the preset icon position towards the real-time icon position; and
adjust, while the sub-character is moving along the initial moving direction, a real-time moving direction of the sub-character during moving based on a first included angle between the first direction and the second direction, allowing for the sub-character to move to the sub-character target position along the real-time moving direction.

19. The electronic device according to claim 17, wherein reception of the first operation on the virtual character is determined by:
determining, upon detecting an operation applied on the preset skill icon, reception of the first operation on the virtual character; or
determining, upon detecting that a sliding start position of the first sliding operation is located on the preset skill icon, reception of the first operation on the virtual character.

20. The electronic device according to claim 11, wherein in a case that the virtual character generates at least two sub-characters, the machine-readable instructions, when being executed by the processor, further cause the electronic device to:
select one sub-character from among the at least two sub-characters as a reference sub-character;
determine a relative positional relationship between the reference sub-character and each other sub-character than the reference sub-character in the at least two sub-characters;
determine, based on the first operation, a first initial moving direction of the reference sub-character; and
determine, for each other sub-character, a second initial moving direction of the other sub-character based on the relative positional relationship between the reference sub-character and the other sub-character.

21. The electronic device according to claim 20, wherein the machine-readable instructions, when being executed by the processor, further cause the electronic device to:
adjust, while the reference sub-character is moving along the first initial moving direction, a reference real-time moving direction of the reference sub-character based on the second operation on the sub-character; and
adjust, for each other sub-character, the real-time moving direction of the other sub-character based on the reference real-time moving direction and the relative positional relationship between the reference sub-character and the other sub-character, allowing for the other sub-character to move to its sub-character target position along its real-time moving direction.

22. The electronic device according to claim 20, wherein in a case that the third operation is a second sliding operation, the machine-readable instructions, when being executed by the processor, further cause the electronic device to:
obtain, upon detecting the second sliding operation applied on a preset skill icon, a preset icon position of the preset skill icon in the graphical user interface and a real-time icon position of the preset skill icon during moving with the second sliding operation, wherein the preset skill icon is an identifier of a skill control for generating the at least two sub-characters;
determine a third direction from the preset icon position towards the real-time icon position;
obtain a fourth direction along which each sub-character moves towards its corresponding position;
determine a target sub-character from among the at least two sub-characters, wherein a second included angle between the third direction and the fourth direction corresponding to the target sub-character is smaller than respective second included angles between the third direction and other fourth directions corresponding to the other sub-characters in the at least two sub-characters; and
control to display the virtual character at a sub-character target position where the target sub-character stops moving, so as to replace the target sub-character.
